(19) United States
(12) Patent Application Publication
(10) Pub. No.: US 2023/0109411 A1
(43) Pub. Date: Apr. 6, 2023

(54) COMPUTER-IMPLEMENTED METHOD OF SEARCHING LARGE-VOLUME UN-STRUCTURED DATA WITH FEEDBACK LOOP AND DATA PROCESSING DEVICE OR SYSTEM FOR THE SAME

(71) Applicant: VV ApS, Copenhagen Ø (DK)

(72) Inventors: Dennis Juul Poulsen, Flensburg (DE); Christian Lawaetz, Copenhagen V (DK); Georgios Kavousanos, Copenhagen K (DK)

(21) Appl. No.: 18/077,889

(22) Filed: Dec. 8, 2022

Related U.S. Application Data
(63) Continuation of application No. PCT/EP2021/065459, filed on Jun. 9, 2021.

(30) Foreign Application Priority Data
Jun. 9, 2020 (DK) PA202070362

(51) Int. Cl. G06F 16/332; G06F 16/33; G06F 16/35

(52) U.S. Cl. CPC G06F 16/3326; G06F 16/3347; G06F 16/35

(57) ABSTRACT

This invention relates to a computer-implemented method of (and a system for) searching clustered data (106), the clustered data (106) representing a multi-dimensional feature space and the method comprising the steps of: obtaining data representing a query feature vector (202) comprising a predetermined number of numerical feature values, projecting the query feature vector (202) into the clustered data (106) and obtaining a number of potential matches (203) determined to be within a pre-determined dimensional range of the query feature vector (202), determining data representing one or more score values for each of the potential matches (203), updating or re-calibrating the query feature vector (202), resulting in a modified query feature vector, in response to the determined one or more score values, projecting the modified query feature vector into the clustered data (106) and obtaining a number of potential matches (203) in response thereto, and repeating the steps of determining data representing one or more score values, updating or re-calibrating the query feature vector (202), and projecting the modified query feature vector into the clustered data (106) and obtaining a number of potential matches (203) in response thereto, until the obtained number of potential matches (203) are satisfactory according to one or more predetermined criteria and then providing the satisfactory potential matches (203) as a search result (206).

### FIELD OF THE INVENTION

The present invention generally relates to a computer-implemented method of searching large-volume un-structured data with feedback loop and related aspects. Additionally, the present invention generally relates to an electronic data processing device or system implementing aspects and embodiments of the computer-implemented method(s).

### BACKGROUND

Searching large volumes on un-structured data, e.g. obtained from the internet, still presents many challenges such as storage requirements, data quality, organizing the data appropriately, and searching accuracy/quality.

It would be useful to provide a computer-implemented method (and system or device for carrying out the computer-implemented method) of searching large-volume un-structured data having increased quality of search results.

It would also be a benefit to have a computer-implemented method (and corresponding system or device) of searching large-volume un-structured data with reduced storage requirements.

### SUMMARY

It is an object to provide a computer-implemented method of searching large-volume un-structured data (and corresponding system or device).

A first aspect of the invention is defined in claim 1.

According to the first aspect, one or more of these objects is/are achieved at least to an extent by a computer-implemented method of searching clustered data, the clustered data representing a multi-dimensional feature space and the method comprising the steps of:
obtaining data representing a query feature vector comprising a predetermined number of numerical feature values,
projecting the query feature vector into the clustered data and obtaining a number of potential matches determined to be within a pre-determined dimensional range of the query feature vector,
determining data representing one or more score values for each of the potential matches,
updating or re-calibrating the query feature vector, resulting in a modified query feature vector, in response to the determined one or more score values,
projecting the modified query feature vector into the clustered data and obtaining a number of potential matches in response thereto, and
repeating the steps of
   determining data representing one or more score values,
   updating or re-calibrating the query feature vector, and
   projecting the modified query feature vector into the clustered data and obtaining a number of potential matches in response thereto,
until the obtained number of potential matches are satisfactory according to one or more predetermined criteria and then providing the satisfactory potential matches as a search result.

In this way, efficient searching of large-volume clustered data is readily provided. The clustered data is preferably derived from a large-volume of un-structured data thereby enabling searching of large-volume un-structured data. The clustered data comprises the data arranged according to a plurality of clusters. By iteratively refining and/or updating the search (i.e. the query feature vector), it is possible to obtain better and better results. It may also be used to find ‘unexpected’ search results, e.g. by selecting at least one search result from each cluster of the clustered data 106 that together with the one or more score values (i.e. feedback) and the updating or re-calibrating of the query feature vector may push the iterative search in new directions (by adjusting subsequent query feature vectors according to whether such search results receives/scores positive or negative feedback). This may lead to search result candidates from different clusters, even far removed clusters, than to where the original query feature vector was projected. In some further embodiments, respective iterations will increase the distance(s) from the originally projected query feature vector to obtain potential matches from more and more clusters. This is continued as long as the scoring/re-calibration provides overall positive feedback/scoring and until overall negative feedback/scoring begins after which the distance(s) (from where they were) are narrowed down again, which may very well be in a different location (of the multi-dimensional space) than where the original query feature vector was projected. It is noted, that the values or possible levels of the respective dimensions of the multi-dimensional space need not, and often will not, be the same. As a simple example, a dimension may e.g. have about 25 or 200 possible values or levels while another may even have more than 10.000 or 100.000.

The one or more score values for each of the potential matches may be derived automatically and/or be derived on the basis of human-based input.

In some embodiments, the step of obtaining data representing a query feature vector comprises
obtaining a user query in a free form text format, and
converting the user query into the query feature vector using computer-implemented natural language processing and/by performing feature hashing using a dictionary data structure on the user query thereby converting respective text data entries into respective feature vectors, each feature vector comprising a number of numerical values where each numerical value represents a particular feature of the feature vector.

In some embodiments, the step of determining data representing one or more score values comprises:
providing the potential matches as input to a pre-trained computer-implemented convolutional neural network, the pre-trained computer-implemented convolutional neural network outputting the one or more score values in response to the provided potential matches.

In some embodiments, the updating or re-calibrating the query feature vector comprises computer-implemented reinforcement learning (e.g. implementing Q-learning or Deep Q learning utilizing a convolutional neural network) and one or more scoring and/or feedback values to derive one or more re-calibration values for features of the query feature vector and updating the query feature vector on the basis of the derived one or more re-calibration values.

In some embodiments, the clustered data has been generated on the basis of a large volume of un-structured data information sources collected and stored as text data entries in a database structure, wherein the generation of the clustered data comprises
performing feature hashing using a dictionary data structure on text data entries of the database structure thereby converting respective text data entries into respective feature vectors, each feature vector comprising a number of numerical values where each numerical value represents a particular feature of the feature vector.

In some embodiments, the clustered data representing a multi-dimensional feature space is created using computer-implemented unsupervised learning implementing association rule learning.

In some embodiments, the method comprises a data enhancement step comprising utilising one or more computer-implemented neural networks, pre-trained on existing structured data, to predict missing or incomplete data or information of one or more text data entries of the database structure.

In some embodiments, the collected text data entries automatically is translated into a target language before or after being stored in the database structure.

According to another aspect of the present invention, a computer system or device is provided wherein the computer system or device is adapted to execute the method(s) and embodiments thereof as disclosed herein.

According to yet another aspect of the present invention, a non-transient computer-readable medium, having stored thereon, instructions that when executed by a computer system or device cause the computer system or device to perform the method(s) and embodiments thereof as disclosed herein.

### Definitions

All headings and sub-headings are used herein for convenience only and should not be constructed as limiting the invention in any way.

The use of any and all examples, or exemplary language provided herein, is intended merely to better illuminate the invention and does not pose a limitation on the scope of the invention unless otherwise claimed. No language in the specification should be construed as indicating any non-claimed element as essential to the practice of the invention.

This invention includes all modifications and equivalents of the subject matter recited in the claims appended hereto as permitted by applicable law.

### BRIEF DESCRIPTION OF THE DRAWINGS

FIG. 1 schematically illustrates a block diagram of data collection from a plurality of data information sources with subsequent data enhancement and data clustering according to some embodiments as disclosed herein;

FIG. 2 schematically illustrates a block diagram of embodiments of searching according to the first aspect as disclosed herein;

FIG. 3 schematically illustrates a visualisation of one example of a created clustered data representing a multi-dimensional feature space according to one exemplary embodiment; and

FIG. 4 schematically illustrates a block diagram of embodiments of an electronic data processing device or system implementing various embodiments of the method(s) disclosed herein.

### DETAILED DESCRIPTION

Various aspects and embodiments of a computer-implemented method and a computer system or device implementing the various aspects and embodiments of the computer-implemented method as disclosed herein will now be described with reference to the figures.

When/if relative expressions such as “upper” and “lower”, “right” and “left”, “horizontal” and “vertical”, “clockwise” and “counter clockwise” or similar are used in the following terms, these typically refer to the appended figures and not necessarily to an actual situation of use. The shown figures are schematic representations for which reason the configuration of the different structures as well as their relative dimensions are intended to serve illustrative purposes only.

Some of the different components are only disclosed in relation to a single embodiment of the invention, but is meant to be included in the other embodiments without further explanation.

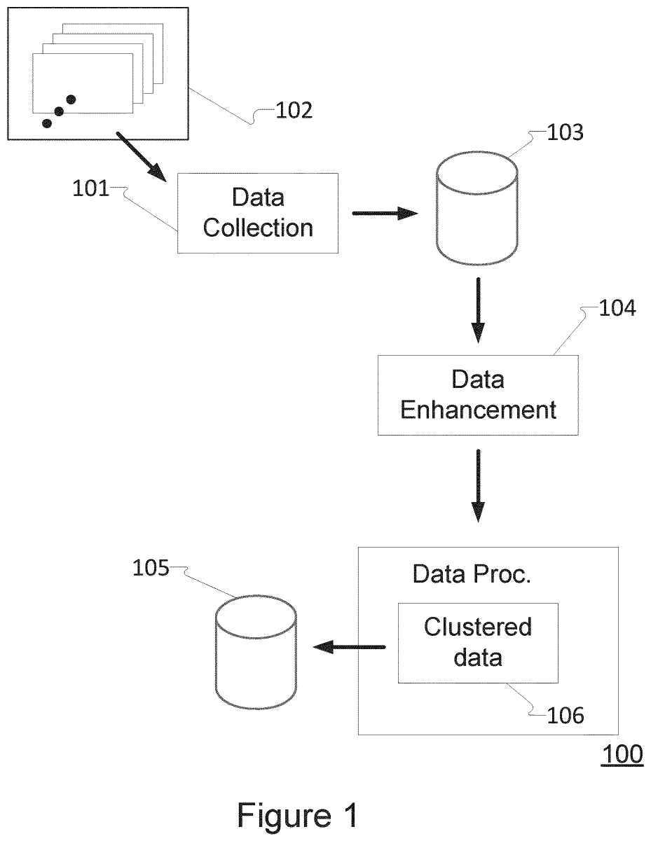

FIG. 1 schematically illustrates a block diagram of data collection from a plurality of data information sources with subsequent data enhancement and data clustering according to some embodiments as disclosed herein.

Schematically illustrated is a large number and volume of data information sources 102, e.g. accessible from a network such as the internet, within a particular context depending on use or implementation. At least a part of the data information sources 102 may be stored in one or more (typical several) public (and/or non-public) databases. In addition, at least some of the information sources 102 are websites, webpages, or the like or content therein. Preferably, the data information sources 102 relate to one or more topics within a same context or area. As one example, the data information sources 102 may e.g. be databases of start-up companies, information about start-up events, etc. and e.g. relate to information about start-up companies, such as one or more of: company name, country of origin, location, technical area(s), sector(s), type of product(s), key people involved, number of employees, origin year, last funding amount and time, funding cycles, social media activity on various platforms, profile information of investors, profile of founders, trend scores (e.g. Crunchbase rank or score), website traffic, website content, tags, contact details, last activity of data information source (is it e.g. updated), etc. Alternatively, the data information sources 102 may relate to other data or information depending on use and application.

Such a large volume of data information sources 102 is in the current context un-structured and/or at least differently structured in an overall way, even though some of the data information sources individually may be organised/structured (e.g. in a publically accessible database, etc.). This presents many challenges in respect to performing high-quality and/or high-speed searches, obtaining accurate search results, obtaining search results being up-to-date, etc. in/amongst such un-organised data information sources 102. In particular if at least some (typically many or most) of the un-organised data information sources 102 more or less continually is updated, new data information sources are added, existing data information sources are removed or become obsolete, and so on. A data information source 102 may e.g. become inactive at least for more than a predetermined period of time. Challenges are e.g. also appropriately handling e.g. changing priority of a data information source 102 or its data or that different data may become available from a new/another data information source 102 and it has to be determined whether existing data should be updated or overwritten or not.

Further illustrated is a data collector element (e.g. of an electronic data processing device or system as disclosed herein) and/or data collection step (e.g. of a computer-implemented method as disclosed herein) 101 that accesses and data mines and collects, preferably automatically, relevant data from the (or at least a large or significant portion) of the un-structured data information sources 102. The mined/collected data is collected in one or more first databases structures (forth equally referred to only as the first database) 103 as, at least in some embodiments, text data.

In some embodiments, the data collector or data collection step 101 continuously or intermittently checks, crawls, or mines (at least a part of) the large volume of data information sources 102 to check for updated information, new relevant information, obsolete information, etc.

According to embodiments of the first aspect as disclosed herein, one or more types of data enhancement 104 is/are performed on or for the collected data of the first database 103. The data enhancement 104 may e.g. be performed by a data enhancement element of an electronic data processing device or system and/or a step of a computer-implemented method as disclosed herein,

In some embodiments, the collected data is automatically translated, e.g. using machine translation, into preferably one target language. The number of different languages that can be translated into the target language e.g. comprises over one hundred languages and dialects. The target language is preferably English but can be another. The translation ensures that homogeneous data or at least more homogenous data (with respect to language) is obtained in the first database 103 and further enables inclusion of relevant data from basically all geographic regions and avoids bias for English information (content and e.g. search candidates). In alternative embodiments, the translation may be performed as part of the data collection 101.

In some embodiments, the data enhancement 104 comprises utilising one or more neural networks or similar to predict missing or incomplete data or information such as sector, country of origin, company stage, funding stage, origin year, etc. Additionally, the data enhancement 104 also uses the one or more neural networks or similar (or alternatively other neural networks) to unify and standardise the data. The prediction and/or unification and standardisation is preferably done for a number of overall data groups, categories, or classes also structurally adhered to in the data collection to be searched.

The one or more neural networks are e.g. (pre-)trained on existing structured data increasing the quality of predictions and thereby the quality of the data. In at least some embodiments, the neural networks are feedforward neural networks that are especially suited for supervised learning, and data/object recognition and prediction.

The predicted completed and/or additional information is stored in the first database 103 or elsewhere.

Alternatives to using such one or more neural networks e.g. includes regression or classification algorithms. These are simpler but work best for relatively small amounts of data input. Compared to these however, such one or more neural networks are typically more flexible, reliable, and dynamical (as they e.g. ongoingly may be trained when new data information sources 102 arises and/or is taken into account).

Advantageously, the prediction of missing or incomplete data or information is done after translating into a single target language greatly simplifying the prediction and the computational work involved therewith.

In some embodiments where data is stored in the first database 103 as text (text data being simpler to mine and collect), the data enhancement 104 comprises conversion that converts the text data of the first database 103 into a predetermined numerical data format. The conversion will typically condense the size of the data by at least one but typically several orders of magnitude thus reducing storage requirements significantly and/or also increasing searching speed or speed of other types of data processing even for large amounts of data. In preferred embodiments, the text-based data stored in the first database 103 is not deleted (to avoid having to collect/build up the data again), but the condensed data representation (resulting from the conversion) is used in subsequent data processing thereby significantly reducing computational processing effort.

In some embodiments, the conversion uses computer-implemented machine learning as part of the conversion. In some further more specific embodiments, the machine learning involves a dictionary data structure and feature hashing that is used to convert text data into the predetermined numerical data format, where the numerical data format is the format of a feature vector. The feature vectors comprise a plurality, e.g. 30 or about 30, of numerical values (as obtained by the dictionary data structure and application of feature hashing) where each numerical value is for a particular feature of the feature vector. Feature hashing is a fast and storage-efficient way of vectorising features, i.e. turning arbitrary features into indices or values in a vector or matrix data structure. The dictionary data structure may ongoingly be improved or updated to increase the quality. The feature hashing also reduces the amount of data significantly. In addition, the feature hashing also serves to unify data.

As a very simple example (with only nine numerical values), two entries of the text data of the first database 103 may e.g. be #1 “An AI platform that optimise the trading and financing of SME's” and #2 “A blockchain empowered platform for trading of cryptocurrency” and the dictionary data structure may e.g. comprise terms and index data according to: Terms (Index): “AI” (1), “platform” (2), “optimise” (3), “trading” (4), “financing” (5), “SME” (6), “blockchain” (7), “empower” (8), “cryptocurrency” (9). In this example, the resulting values of the predetermined numerical data format (i.e. the respective feature vectors) would have the values (1, 1, 1, 1, 1, 1, 0, 0, 0) (for #1) and (0, 1, 0, 1, 1, 0, 1, 0, 1) (for #2). This (in addition to reducing amount of data used for representing the text data) e.g. also readily identify or indicate the similarities that exist between the two text descriptions for the terms having indices 2 (“platform”), 4 (“trading”), and 5 (“financing”). The inventors have for example realised a dictionary data structure comprising more than 100.000 relevant words and appropriate indices for a particular context (start-up data and information).

In addition to condensing, the numerical values (i.e. values of the feature vectors) also serves as an expedient way of unifying data representing differently worded textual passages. Similarities in values between different feature vectors (i.e. where the values are the same at respective indices (e.g. two feature vectors both have “1” or “0” at index 3, etc.) can be used to group together similar feature vectors e.g. in clusters (see further in the following).

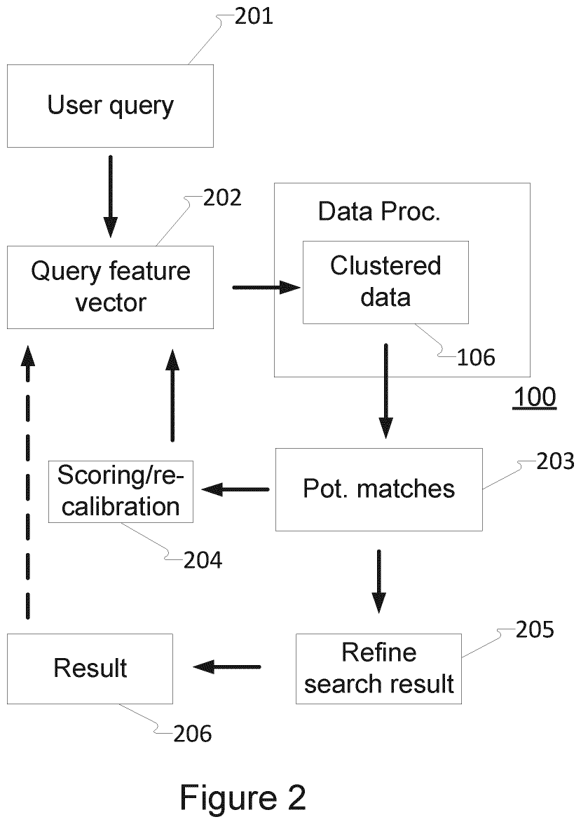

As a result, a (at least one) feature vector or feature matrix (forth equally referred to only as feature vector) is created for, at least in some embodiments, each potential search result entry or item being built into an efficiently searchable database (see also FIG. 2).

In some embodiments, data representing a multi-dimensional feature space is created representing the searchable entries or items of the collected (and preferably data enhanced) data from the feature vectors derived on the basis of the data of the first database 103. The data representing a multi-dimensional feature space is created or obtained by a data processing element of an electronic data processing device or system and/or a data processing step of a computer-implemented method 100 as disclosed herein. In some embodiments, the data representing a multi-dimensional feature space is created using suitable computer-implemented machine learning, e.g. unsupervised learning. In some further embodiments, the data representing a multi-dimensional feature space is created using computer-implemented unsupervised learning implementing association rule learning so that the data representing a multi-dimensional feature space is created as clustered data 106. The clustered data 106 may e.g. be stored in one or more second database structures 105 (forth equally referred to only as the second database). The computer-implemented association rule learning is used to predict or estimate a certain overall category or class by processing a subset of data and to determine what the most likely outcome is. Alternatively, other computer-implemented classification methods are used instead of association rule learning, e.g. regression, decision trees (e.g. boosted or random forest), or the like. However, these are typically not as flexible and efficient to use as association rule learning for large volumes of data; but for certain uses and implementations they may still suffice.

The data of the created multi-dimensional space provides a very storage efficient way of storing the collected data (or rather a suitable searchable data representation thereof) and require much less storage space than the corresponding information in the original text format. The more efficient (storage requirement wise) searchable data representation also provides much faster and much more efficient data processing and thereby faster searching enabling searching of very large volumes of data (e.g. with several hundred thousand of clustered entries).

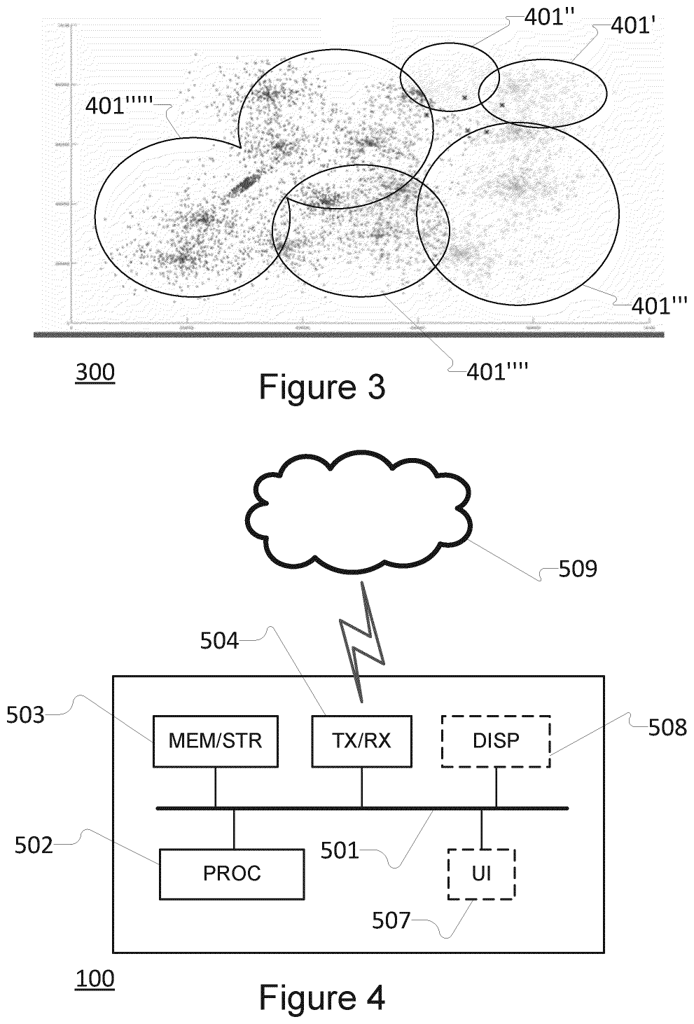

In this way, clustered searchable data entries are created where data entries with similarities (between the features) are closer together in the multi-dimensional space (see e.g. FIG. 3 illustrating a visualisation of one example of created clustered data representing a multi-dimensional feature space according to one exemplary embodiment). The number of data entries may e.g. be several hundred thousand and may e.g. related to startup companies.

At least some of the data enhancement 104 may e.g. also be carried out before and/or as part of storing information in the first database 103.

In at least some embodiments, the first database 103 is a temporary database. In some embodiments, the first and the second databases 103, 105 may be different parts, e.g. a first part (corresponding to the first database 103 as disclosed herein) and a second part (corresponding to the second database 105 as disclosed herein), of the same database structure.

FIG. 2 schematically illustrates a block diagram of embodiments of searching according to the first aspect as disclosed herein.

Illustrated is a data processing element (of an electronic data processing device or system) and/or a data processing step (of a computer-implemented method) 100 as disclosed herein. In some embodiments, the data processing element and/or data processing step 100 corresponds to one designated 100 in FIG. 1. Alternatively, it may be a different element and/or step.

In some embodiments, the data processing element and/or data processing step 100 processes clustered data 106 as described in the following. The clustered data 106 may e.g. be stored in a second database (see e.g. 105 in FIG. 1). In preferred embodiments, the clustered data 106 has been generated by an embodiment as described in connection with FIG. 1 and/or as disclosed elsewhere herein.

Preferably, the clustered data 106 are data representing a multi-dimensional feature space of feature vectors representing searchable entries or items of collected (and e.g. data enhanced) data (see e.g. FIG. 1).

Further schematically illustrated is a user query 201, comprising a number of search-related terms and/or parameters, obtained in any suitable way e.g. via a suitable (graphical) user interface on a client or user device. At element or step 202, the user query 201 is translated, converted, and/or calibrated into a query feature vector 202 suitable for searching amongst the clustered data 106. In some embodiments, the user query 201 is provided in a free form text format and is converted, e.g. or preferably using natural language processing, into a multi-dimensional query feature vector comprising a number of feature values as derived on the basis of (and representing) the free from text input. The feature vector typically has the same dimensionality and structure as that of the feature space (or is at least compatible with it) as represented by the clustered data 106. The conversion of the user query 201 into the feature query vector 201 is similar (or at least comprises some of the same elements/functionality) and may (more or less) be done in the same way as converting the collected data sources into the clustered data (representing a multi-dimensional feature space) as described in connection with FIG. 1, e.g. using a dictionary data structure and computer-implemented feature hashing converting text data (the user query 201) into the query feature vector 202 having a predetermined numerical data format.

As a simple example, the user query 201 could e.g. be “Identify platforms that work within the financial sector to support SME's and their trading activities”. Using the dictionary data structure from the example above and feature hashing, the resulting query feature vector 202 would be (1, 0, 1, 1, 1, 1, 0, 0, 0).

The query feature vector 202 is then projected into the multi-dimensional feature space as represented by the clustered data 106 whereby a number of data entries of the clustered data 106 within a pre-determined multi-dimensional range (i.e. within close proximity) of the query feature vector 202 may be identified and retrieved or obtained as a search result referred to in the figure as potential matches 203. Additionally or alternatively, only a certain designated number (e.g. 10, 20, or 25) of search results, then being the closest certain designated number of results, are identified and retrieved or obtained as the search result. The search result may e.g. be provided according to: return e.g. 10 entries of the clustered data 106 that is closest to the projected feature vector 202 or e.g. according to: return all entries of the clustered data 106 that is within the projected feature vector 202 by a pre-determined multi-dimensional range (where the range values may be different for different dimensions).

It is noted, that a search in the clustered data 106 may involve a plurality of users queries 201 (and thereby a plurality of query feature vectors 201) and closest matches for each.

Please see FIG. 3 for an example of clustered data 106 and a number of projected query feature vectors 202. FIG. 3 schematically illustrates a visualisation of one example of created clustered data 406 representing a multi-dimensional feature space illustrating a number of clusters (indicated very schematically and here five clusters as an example) 401′, 401″, 401′″, 401″″, and 401″″ and five projections in the multi-dimensional feature space indicated (by crosses) being the result of applying or projecting five different query feature vectors 202 (respectively for five different user queries 201).

Each applied or projected query feature vector 202 (as represented by a cross) represents an ‘ideal’ search result for a user query 201 and is used to determine the ‘closest’ search result candidates.

In some embodiments, the potential matches 203 is directly used as the search result 206 in response to each user query 201 of the particular search (i.e. a number of closest candidates of (each of) the projected query feature vectors 202 are the search result 206).

However, in alternative preferred embodiments and according to the first aspect as disclosed herein, the potential matches 203 are used as feedback in an iterative search improvement process, which will increase the search quality even further.

According to such preferred embodiments, a scoring/re-calibration element or step 204 receives the potential matches 203 (which may then be seen as an intermediate search result) and automatically updates or adjusts the query vector 202 on the basis of the potential matches 203 and an output or result of scoring and/or feedback (by the scoring/re-calibration element or step 204) also done on the basis of potential matches 203. The scoring and/or feedback by the scoring/re-calibration element or step 204 may involve human-based input, e.g. in the form of presenting a number of search result candidates (i.e. the potential matches 203) and receiving votes for best suited candidate(s) or other negative and positive feedback.

The updating or adjustment of the query feature vector may be based on what vector values are different between the projected query feature vector and a potential match together with a scoring and/or feedback.

As a very simplified example, take a projected query feature vector 202 to be (1, 0, 1, 1, 1, 1, 0, 0, 0) and a potential match 203 is represented by (1, 0, 1, 1, 1, 1, 0, 0, 1). If the automatic scoring and/or feedback (that may or may not include human-based input) is positive in relation to the potential match 203 (1, 0, 1, 1, 1, 1, 0, 0, 1), then the part(s)/value(s) of the projected query feature vector 202 that is not similar to the potential match 203 is changed or aligned (re-calibrated) towards to values of the (positively scored) potential match 203. Continuing the example, the query feature vector 202 (for a next iteration) may be re-calibrated to be (1, 0, 1, 1, 1, 1, 0, 0, 1), i.e. changing the last part/value to be that of the last part/value of the (positively scored) potential match 203. As mentioned, this is a very oversimplified example. Typically, there will be a plurality of potentially matches 203 and the aim is to adjust only relevant parts/values of the query feature vector to achieve a maximum or at least increased alignment with as many of the (positively scored) plurality of potentially matches 203 as possible while not being similar with potentially matches 203 that scored negatively.

In some embodiments, the scoring/re-calibration element or step 204 comprises computer-implemented machine learning. In some further embodiments, the scoring/re-calibration element or step 204 comprises machine learning in the form of computer-implemented reinforcement learning e.g. implementing Q-learning or Deep Q learning utilizing a convolutional neural network and one or more scoring and/or feedback values to derive one or more re-calibration values for features of the query feature vector used to update the query feature vector 202 as indicated by the arrow from the scoring/re-calibration element or step 204 to the query feature vector 202. In essence, a more accurate updated query feature vector is provided that in turn may be projected into the multi-dimensional feature space as represented by the clustered data 106.

The human-based input and/or feedback on the derived candidates/potential matches 203 may e.g. be used to (further) train or optimize the convolutional neural networks, which then according to the (further) training or optimization adjusts the query feature vector 202.

This (elements/steps 202, 100, 203, 204) may be, a preferably is, iterated a number of times until the derived potential matches 203 are satisfactory according to one or more criteria.

In at least some embodiments, the scoring/re-calibration element or step 204 includes human feedback.

In some further embodiments, the potential matches 203 includes or further includes at least one search result from each cluster of the clustered data 106, which is included in the data processing of the scoring/re-calibration element or step 204 to provide scoring or feedback. The at least one search result from each cluster is/are search results from each cluster within a pre-determined dimensional range of the query feature vector 202 or simply a group of search results (one or more) being closest to the query feature vector 202. Selecting at least one search result from each cluster of the clustered data 106 “mimics” or introduces a creative element or contribution to the potential matches, which together with the scoring/re-calibration element or step 204 may push the iterative search in new directions (by adjusting subsequent query feature vectors according to whether such search results receives/scores positive or negative feedback). This may lead to search result candidates from different clusters, even far removed clusters, than to where the original query feature vector was projected. In some embodiments, different iterations of 202, 203, and 204 will increase the distance(s) from the originally projected query feature vector to obtain potential matches 203 from more and more clusters. This is continued as long as the scoring/re-calibration element or step 204 provides overall positive feedback/scoring and until overall negative feedback/scoring begins after which the distance(s) (from where they were) are narrowed down again, which may very well be in a different location (of the multi-dimensional space) than where the original query feature vector was projected.

Once the potential matches 203 are deemed satisfactory, the potential matches 203 becomes the search result 206.

In some embodiments, the satisfactory potential matches 203 are forwarded to a refine search result element or step 205 that enriches the potential matches 203 before becoming the search result 206.

In some embodiments (and as indicated by the hashed arrow from search result 206 to query feature vector 202), the search result 206 is used for training and/or alignment for future similar or related searches. This provides high quality training and/or alignment since the results from a search is a most “accurate” input for what the preferences was and how to find them based on all the steps described above.

FIG. 3 schematically illustrates a visualisation of one example of a created clustered data representing a multi-dimensional feature space according to one exemplary embodiment.

Illustrated in FIG. 3 is graph 300 of a large number of searchable entries or items, where each dot represent a single entry or item as given by specific values of a respective feature vector. Further illustrated is a number of clusters (here five as an example) 401′, 401″, 401′″, 401″″, and 401″″. The colour value/intensity of each dot designates a cluster that a given dot (i.e. a given feature vector) belongs to.

Additionally for clarity, each cluster is also (very schematically) indicated in an overall way by a respective circle or combined circles with imperfect boundaries and imperfect overlap to provide a rough indication of the clusters. In the shown example, the multi-dimensional feature space is thirty-dimensional and the feature vectors each comprises thirty feature values.

Additionally illustrated (by crosses) are five search results or potential candidates being a result of applying a query feature vector (see e.g. 202 in FIG. 2) as disclosed herein.

The clusters of feature vectors have been generated as described in connection with FIG. 1.

FIG. 4 schematically illustrates a block diagram of embodiments of an electronic data processing device or system implementing various embodiments of the method(s) disclosed herein.

Shown is a representation of an electronic data processing system or device 100 comprising one or more processing units 502 connected via one or more communications and/or data buses 501 to an electronic memory and/or electronic storage 503, one or more signal transmitter and receiver communications elements 504 (e.g. one or more selected from the group comprising cellular, Bluetooth, WiFi, etc. communications elements) for communicating via a computer network, the Internet, and/or the like 509, an optional display 508, and one or more optional (e.g. graphical and/or physical) user interface elements 507.

The electronic data processing device or system 100 can e.g. be a suitably programmed computational device, e.g. like a PC, laptop, computer, server, smart-phone, tablet, etc. and comprises the functional elements and/or is specifically programmed to carry out or execute steps of the computer-implemented method(s) and embodiments thereof as disclosed herein and variations thereof.

Some preferred embodiments have been shown in the foregoing, but it should be stressed that the invention is not limited to these, but may be embodied in other ways as falling within the subject matter as defined in the accompanying claims.

In the claims when enumerating several features, some or all of these features may be embodied by one and the same element, component, item or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components, or groups thereof.

1. A computer-implemented method of searching clustered data, the clustered data representing a multi-dimensional feature space and the method comprising the steps of:
obtaining data representing a query feature vector comprising a predetermined number of numerical feature values,
projecting the query feature vector into the clustered data and obtaining a number of potential matches determined to be within a pre-determined dimensional range of the query feature vector,
determining data representing one or more score values for each of the potential matches,
updating or re-calibrating the query feature vector, resulting in a modified query feature vector, in response to the determined one or more score values,
projecting the modified query feature vector into the clustered data and obtaining a number of potential matches in response thereto, and
repeating the steps of
determining data representing one or more score values,
updating or re-calibrating the query feature vector, and
projecting the modified query feature vector into the clustered data and obtaining a number of potential matches in response thereto,
until the obtained number of potential matches are satisfactory according to one or more predetermined criteria and then providing the satisfactory potential matches as a search result.

2. The computer-implemented method according to claim 1, wherein the step of obtaining data representing a query feature vector comprises
obtaining a user query in a free form text format, and
converting the user query into the query feature vector using computer-implemented natural language processing and/by performing feature hashing using a dictionary data structure on the user query thereby converting respective text data entries into respective feature vectors, each feature vector comprising a number of numerical values where each numerical value represents a particular feature of the feature vector.

3. The computer-implemented method according to claim 1, wherein the step of determining data representing one or more score values comprises:
providing the potential matches as input to a pre-trained computer-implemented convolutional neural network, the pre-trained computer-implemented convolutional neural network outputting the one or more score values in response to the provided potential matches.

4. The computer-implemented method according claim 1, wherein the updating or re-calibrating the query feature vector comprises computer-implemented reinforcement learning, a implementing Q-learning or Deep Q learning utilizing a convolutional neural network, and one or more scoring and/or feedback values to derive one or more re-calibration values for features of the query feature vector and updating the query feature vector on the basis of the derived one or more re-calibration values.

5. The computer-implemented method according to claim 1, wherein the clustered data has been generated on the basis of a large volume of un-structured data information sources collected and stored as text data entries in a database structure, wherein the generation of the clustered data comprises
performing feature hashing using a dictionary data structure on text data entries of the database structure thereby converting respective text data entries into respective feature vectors, each feature vector comprising a number of numerical values where each numerical value represents a particular feature of the feature vector.

6. The computer-implemented method according to claim 5, wherein the clustered data representing a multi-dimensional feature space is created using computer-implemented unsupervised learning implementing association rule learning.

7. The computer-implemented method according to claim 5, wherein the method comprises a data enhancement step comprising utilising one or more computer-implemented neural networks, pre-trained on existing structured data, to predict missing or incomplete data or information of one or more text data entries of the database structure.

8. The computer-implemented method according to claim 5, wherein collected text data entries automatically is translated into a target language before or after being stored in the database structure.

9. An electronic computer system or device wherein the computer system or device is adapted to execute the method according to claim 1.

10. A non-transient computer-readable medium, having stored thereon, instructions that when executed by a computer system or device cause the computer system or device to perform the method according to claim 1.
